(19) United States
(12) Patent Application Publication
(10) Pub. No.: US 2015/0186435 A1
(43) Pub. Date: Jul. 2, 2015

(54) HISTORY MANAGEMENT APPARATUS, HISTORY MANAGEMENT METHOD AND HISTORY MANAGEMENT PROGRAM

(71) Applicant: P&W Solutions Co., Ltd., Tokyo (JP)

(72) Inventor: Toshiyuki OMIYA, Tokyo (JP)

(21) Appl. No.: 14/538,606

(22) Filed: Nov. 11, 2014

(30) Foreign Application Priority Data
Dec. 26, 2013 (JP) 2013-269036

(51) Int. Cl. G06F 17/30

(52) U.S. Cl. CPC G06F 17/30321

(57) ABSTRACT

A history generation part generates a history data set including a duration of each call in each state for each of a plurality of agents. With a degree of evenness of durations for each call in a predetermined state for a predetermined agent as an evaluation index, an evaluation index generation part generates information indicating the evaluation index itself or information used for calculating the evaluation index, as information of an evaluation index based on the history data. An image generation part generates a data set of a display image indicating the evaluation index based on the information of the evaluation index. A display control part causes the display image to be displayed on a display unit.

This application is based on and claims the benefit of priority from Japanese Patent Application No. 2013-269036, filed on 26 Dec. 2013, the content of which is incorporated herein by reference.

### BACKGROUND OF THE INVENTION

1. Field of the Invention

The present invention relates to a history management apparatus, a history management method, and a history management program that manage a history of actions on a telephone switchboard.

2. Related Art

Conventionally, in a contact center, each action such as connection, hold and transfer of a line has been executed based on an incoming call from a client or an outgoing call from an agent by way of PBX (Private Branch eXchange) or CTI (Computer Telephony Integration).

In addition, it has been proposed to manage as statistical information by associating these actions with an agent who is the source of the operation (for example, refer to Japanese Unexamined Patent Application, Publication No. 2012-044569).

### SUMMARY OF THE INVENTION

However, PBX or CTI records or outputs individual actions as a fragment of a response at a certain moment of the contact center. In addition, since the operational history of an agent is accumulated as statistical information also by the technology of Japanese Unexamined Patent Application, Publication No. 2012-044569, these fragments are not associated, and it has been difficult to understand the sequence of response history relative to one incoming call or outgoing call.

For this reason, the Applicant of the present application has filed the application including the invention of providing a history management apparatus, history management method and history management program that allow for the history of responses to one call to be easily understood (Japanese Unexamined Patent Application No. 2012-180961).

After filing the application, a situation arises which requires to appropriately evaluate each agent based on the history of the response to each call for each agent.

The present invention was made by considering such a situation, and has an object of providing a history management apparatus, a history management method, and a history management program that can appropriately evaluate each agent.

A history management apparatus according to an aspect of the present invention includes: a history generation part that generates a history data set including a duration of each call in each state for each of a plurality of agents; an evaluation index generation part that, with a degree of evenness of durations for each call in a predetermined state for a predetermined agent as an evaluation index, generates information indicating the evaluation index itself or information used for calculating the evaluation index, as information of an evaluation index based on the history data; an image generation part that generates a data set of a display image indicating the evaluation index based on the information of the evaluation index; and a display control part that causes the display image to be displayed on a display unit.

A history management apparatus according to an aspect of the present invention further includes an acquisition part that acquires a fragment data set indicating an action of a switchboard in relation to a call and an execution time of the action, and the history generation part can generate the history data set indicating a history of states of an agent to one call, from a plurality of fragment data sets acquired by the acquisition part.

The evaluation index generation unit can generate, as the information of the evaluation index, at least one of a dispersion and standard deviation of durations of the predetermined state for the predetermined agent, and the image generation part can generate data of the display image indicating the information of the evaluation index.

The evaluation index generation part can generate, as the information of the evaluation index, information for calculating a distribution state of durations in the predetermined state for the predetermined agent, and the image generation part can generate data of the display image including a band graph or a histogram indicating a distribution state of durations in the predetermined state based on the information of the evaluation index.

A history management method executed by a computer, according to an aspect of the present invention includes: a history generation step of generating a history data set including a duration of each call in each state for each of a plurality of agents; an evaluation index generation step of, with a degree of evenness of durations for each call in a predetermined state for a predetermined agent as an evaluation index, generating information indicating the evaluation index itself or information used for calculating the evaluation index, as information of an evaluation index based on the history data; an image generation step of generating a data set of a display image indicating the evaluation index based on the information of the evaluation index; and a display control step of causing the display image to be displayed on a display unit.

A non-transitory computer-readable medium encoded with a history management program according to an aspect of the present invention that enables a computer to execute: a history generation step of generating a history data set including a duration of each call in each state for each of a plurality of agents; an evaluation index generation step of, with a degree of evenness of durations for each call in a predetermined state for a predetermined agent as an evaluation index, generating information indicating the evaluation index itself or information used for calculating the evaluation index, as information of an evaluation index based on the history data; an image generation step of generating a data set of a display image indicating the evaluation index based on the information of the evaluation index; and a display control step of causing the display image to be displayed on a display unit.

According to the present invention, it is possible to evaluate each agent appropriately.

### BRIEF DESCRIPTION OF THE DRAWINGS

FIG. 1 is a block diagram showing a functional configuration of a history management apparatus according to an embodiment;

FIG. 2 is a view showing an example of fragment data according to an embodiment;

FIG. 3 is a view showing a portion of history data according to an embodiment;

FIG. 4 is a view showing an example of a first screen according to an embodiment;

FIG. 5 is a view showing an example of a second screen according to an embodiment;

FIG. 6 is a view showing an example of a third screen according to an embodiment;

FIG. 7 is a view showing an example of a fourth screen according to an embodiment;

FIG. 8 is a view showing an example of a fifth screen according to an embodiment;

### DETAILED DESCRIPTION OF THE INVENTION

Hereinafter, embodiments of the present invention will be explained.

A history management apparatus 1 according to the present embodiment performs display control for allowing a manager to understand the history of response states of an agent relative to one call (incoming call or outgoing call) in a contact center, and also performs display control for appropriately evaluating agents. It should be noted that, hereinafter, the agents are also called “operators” as appropriate.

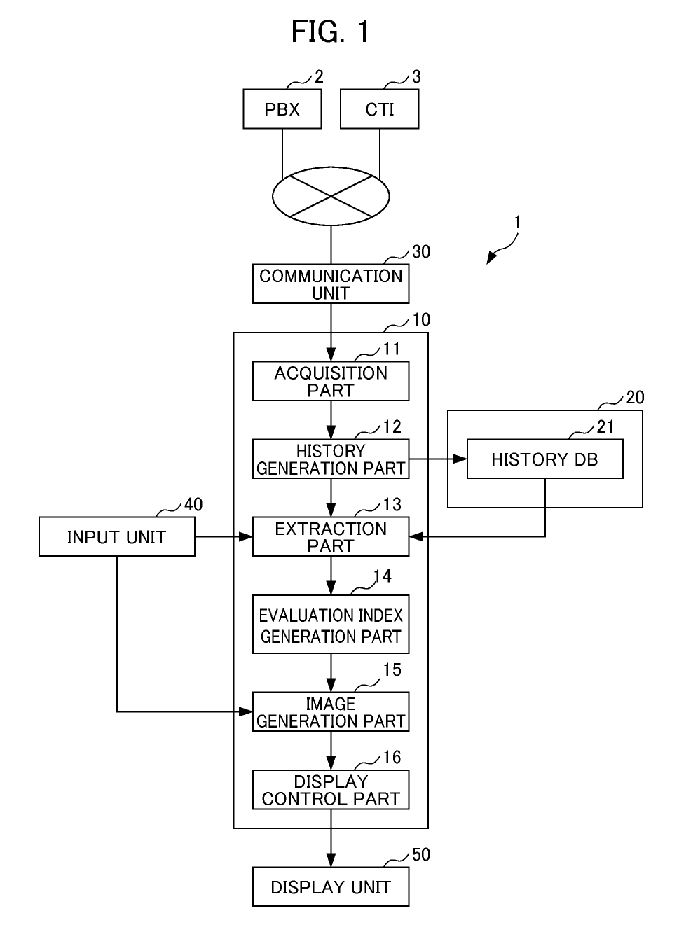

FIG. 1 is a block diagram showing a functional configuration of a history management apparatus 1 according to the present embodiment.

The history management apparatus 1 includes a control unit 10, storage unit 20, communication unit 30, input unit 40 and display unit 50. In addition, the history management apparatus 1 is connected with PBX 2 and CTI 3 via a predetermined network.

The control unit 10 is a portion controlling the history management apparatus 1 overall, and cooperates with the above-mentioned hardware to realize various functions of the present embodiment, by reading and executing various programs stored in the storage unit 20 as appropriate. The control unit 10 may be a CPU (Central Processing Unit). It should be noted that the functions of each part included in the control unit 10 will be described later.

The storage unit 20 is a storage area of various programs for causing hardware groups to function as the history management apparatus 1, various data, etc., and may be a HDD (Hard Disk Drive), flash memory, or the like. More specifically, a program to be executed in the control unit 10 for realizing the various functions of the present embodiment (history management program) is stored in the storage unit 20.

In addition, the storage unit 20 includes a history DB 21 that stores history data (described later) generated by the control unit 10.

The communication unit 30 is a network adaptor for a case of the history management apparatus 1 sending and receiving data with another apparatus. The communication unit 30 performs data communication with PBX 2 or CTI 3 via the network.

The input unit 40 is an interface device accepting the command inputs from an operator, i.e. manager of a contact center, to the history management apparatus 1. The input unit 40 is configured from a keyboard, mouse, touch panel, or the like, for example.

The display unit 50 is a display device that displays to the operator a screen for accepting the input of data, and displays a screen of processing results by the history management apparatus 1, according to the control of the control unit 10. The display unit 50 may be a display device such as a CRT (Cathode-Ray Tube) display device, LCD (Liquid Crystal Display) device, or the like.

Next, functions of the control unit 10 will be described in detail.

The control unit 10 includes an acquisition part 11, history generation part 12, extraction part 13, evaluation index generation part 14, image generation part 15, display control part 16. These respective parts are functional blocks realized by the control unit 10 executing the history management program.

The acquisition part 11 acquires, via the communication unit 30 from PBX 2 or CTI 3, fragment data indicating an action of PBX 2 to a call and the execution time of this action.

The fragment data acquired is data indicating the action performed by PBX 2 or CTI 3 at a certain moment, and a mutual association between a plurality of fragment data sets is not made. More specifically, in the case of there being a plurality of incoming consecutively to one line of the contact center, for example, the fragment data acquired in time series from PBX 2 or CTI 3 is not grouped in a unit of incoming, and the data relating to the plurality of incoming is mixed.

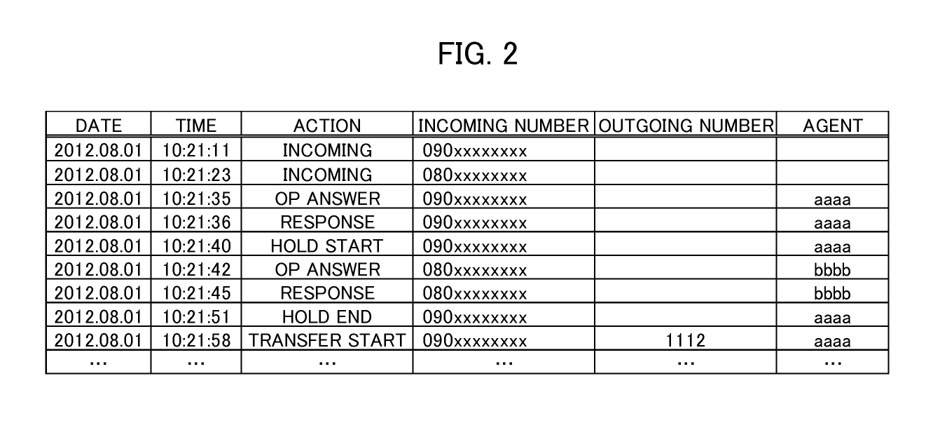

FIG. 2 is a view showing an example of fragment data according to the present embodiment.

In this example, the action of PBX 2, incoming number, calling (outgoing) number, and response handling agent (hereinafter, also referred to as “operator”) are outputted relative to the data and time. In these fragment data sets acquired in time series, the fragment data related to a call received from an incoming number “090xxxxxxxx” and the fragment data related to a call received from an incoming number “080xxxxxxxx” are mixed.

The history generation part 12 generates history data showing the history of response states of an agent relative to one call, from the plurality of fragment data sets acquired by the acquisition part 11.

Since history such as the duration and the number of times of each response state, which vary depending on a series of actions relative to one call, are not included in the fragment data sets of FIG. 2, the history generation part 12 first sorts the fragment data sets according to the incoming number.

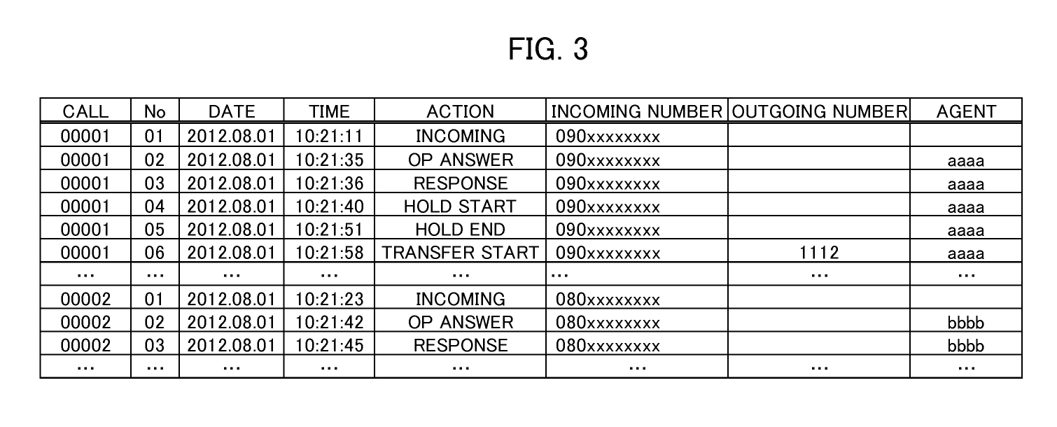

FIG. 3 is a view showing a part of history data generated by the history generation part 12 according to the present embodiment.

In this example, the history generation part 12 extracts a series of fragment data related to one call starting from incoming, and groups according to identification data and sequence number (No) of the call.

Furthermore, the history generation part 12 calculates the duration, number of times, etc. of each response state, which vary depending on the series of actions, respectively, based on the fragment data sets grouped, and stores as a part of the history data along with the identification data of the call.

For example, the time from “incoming” until “operator (OP) answer” is the duration of the “waiting” state and stored as “waiting time”. Furthermore, the time from “operator (OP) answer” until “response” is stored as “incoming duration” with the number of times. Here, incoming duration refers to a duration of a “ringing” state in which, although a phone of the agent is receiving an incoming call (although the phone is ringing), the agent has not picked up the phone call yet (hereinafter, referred to as “incoming” state). Furthermore, the total of the times from “hold start” to “hold end” is stored as a duration of a state of “hold”, i.e. as “hold time” with the number of times. Furthermore, in the time from “response” until “disconnect” or “transfer end”, the time excluding the “hold time” is stored as a duration of a state (operation) of “call-talk”, i.e. as “call duration” with the number of times.

Moreover, in a case of the agent performing post-processing such as recording relating to the call after talking, the duration of the state (operation) of this “post-processing time” is accumulated in CTI 3 with the number of times. This “post-processing time” is stored as a part of history data by the history generation part 12, after being acquired as fragment data by the acquisition part 11.

In addition, among the time from when one call ends until a next call starts, a duration of a state in which the agent is seated and is able to pick up the phone call at any time (idle state) is stored as “idle time” and a duration of a state in which the agent is away from his/her seat is stored as “away state”, as a part of history data by the history generation part 12, after being acquired by the acquisition part 11 with the number of times.

In other words, the history generation part 12 generates history data including the duration of each call in each state for each of a plurality of agents.

It should be noted that the sales amount as well as the number of times of sales are stored as a part of history data by the history generation part 12. Hereinafter, the state in which an agent makes sales in this way is referred to as a state of “actual performance”.

The extraction part 13 receives the input of search criterion for screening from history data stored in the history DB 21, and extracts history data satisfying this search criterion.

The evaluation index generation part 14 generates information indicating an evaluation index itself of each agent or information used for computing the evaluation index (hereinafter called “evaluation index information”), based on the history data extracted by the extraction part 13. It should be noted that the evaluation index is described later.

The image generation part 15 generates data of a display image indicating the history of respective states for each agent (including a response state to a call), based on the history data extracted by the extraction part 13. Furthermore, the image generation part 15 generates data of a display image indicating an evaluation index for each agent based on the evaluation index information generated by the evaluation index generation part 14.

The display control part 16 causes a display image generated by the image generation part 15 to be displayed on the display unit 50.

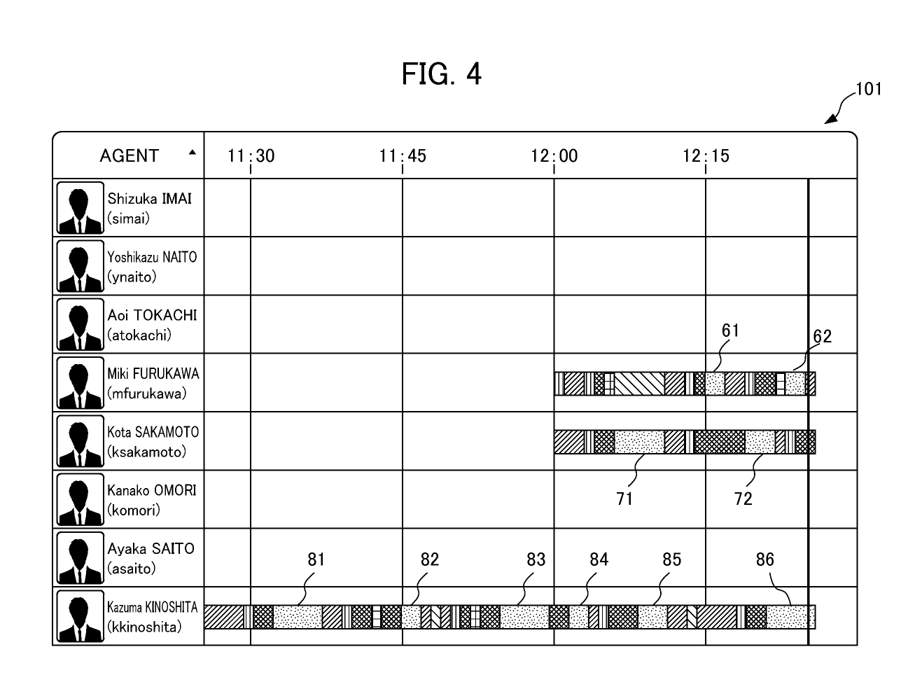

More specifically, the image generation part 15 generates data of a first screen 101 as shown in FIG. 4 as an example, as data of a display image indicating the history of respective states for each agent (including a response state to a call).

As shown in FIG. 4, in the first screen 101, band graphs are respectively included for each agent, in which each band (items of rectangular shape) indicating the history of each state (including a response state to a call) is arranged in a time series with a length corresponding to its duration.

In the example of FIG. 4, the respective bands indicating each state are distinguished by different types of hatching. For example, bands 61 and 62 for “Mild Furukawa”, bands 71 and 72 for “Kouta Sakamoto”, and bands 81 to 86 for “Kazuma Kinoshita” are illustrated with the same hatching, all of which specifically indicate a state of “call-talk”.

It should be noted that it is preferable for the respective bands indicating each state to be easily recognized visually when being distinguished based on different colors on an actual screen.

Such a first screen 101 has already been realized by applying the invention according to the above-identified Japanese Patent Application No. 2012-180961, filed by the applicants of the present application.

Given the above, upon the analyzing the first screen 101 to actual actions by each of the plurality of agents, the applicants of the present application acquired the following knowledge.

In other words, the applicants of the present application acquired the knowledge that an agent (operator) who performs his/her operations promptly so that the agent can answer more phone calls, can be evaluated as a high-quality call-talk agent (operator) as a result of monitoring and such an agent has a tendency of the length of each band indicating each state (each operation) becoming approximately even, i.e. a tendency of a duration of each call in each state becoming approximately even.

On the other hand, the applicants of the present application acquired the knowledge that an agent having a length of each band indicating each state that is uneven (i.e. a duration of each call of each state is uneven) easily gets swayed with the conversation with customers, cannot answer questions well from customers, or cannot keep the conversation going successfully, as a result of monitoring actual performance.

Given the above, the applicants of the present application conceived of adopting the degree of evenness of durations (lengths of each band indicating a predetermined state) for each call in a predetermined state (for example, call duration) with respect to a predetermined agent as an evaluation index for the predetermined agent. Moreover, the applicants of the present application devised an invention of generating data of a display image indicating an evaluation index with “the degree of evenness of durations for each call in a predetermined state” as an evaluation index, and displaying the display image.

Here, the expression method for the display image of “the degree of evenness of durations for each call in a predetermined state” is not limited in particular. Therefore, a method of expressing with numerical values such as “dispersion”, “standard deviation” or the like of a duration of each call in a predetermined state (hereinafter, referred to as “numerical value index method”) may be adopted. Furthermore, a method of expressing with a graph (for example, band graph and histogram) indicating a distribution state of durations of each call in a predetermined state (hereinafter, referred to as “graph index method”) may be adopted.

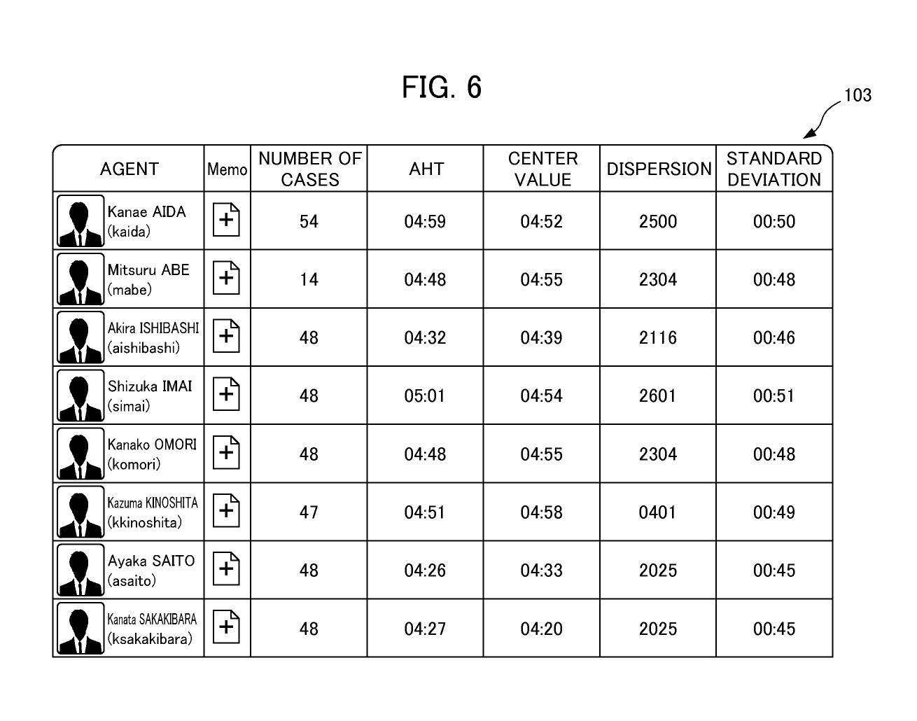

An example to which the method of expressing “the degree of evenness of durations for each call in a predetermined state” with the numerical value index method, i.e. numerical values of such as “dispersion” or “standard deviation” is applied is illustrated in FIG. 6, which is described later.

In a case of such numerical value index method being applied, for example, the evaluation index generation part 14 calculates an accumulated value of durations for each call in each state such as “call duration” for each agent. Then, the evaluation index generation part 14 generates statistic information of each state based on the accumulated values and the number of times (accumulation of the number of operations) of each state.

Regarding the statistic information for each state, in the present embodiment, “AHT”, “center value”, “dispersion”, and “standard deviation”, which represents each state such as call-talk, are generated. “AHT” stands for “Average Handle Time” and is a time that is calculated as an average of “call duration” and “post-processing time”, for example.

Among such statistic information, “dispersion” and “standard deviation” are evaluation index information indicating “the degree of evenness of durations for each call in a predetermined state” itself, i.e. evaluation index information indicating the evaluation index itself.

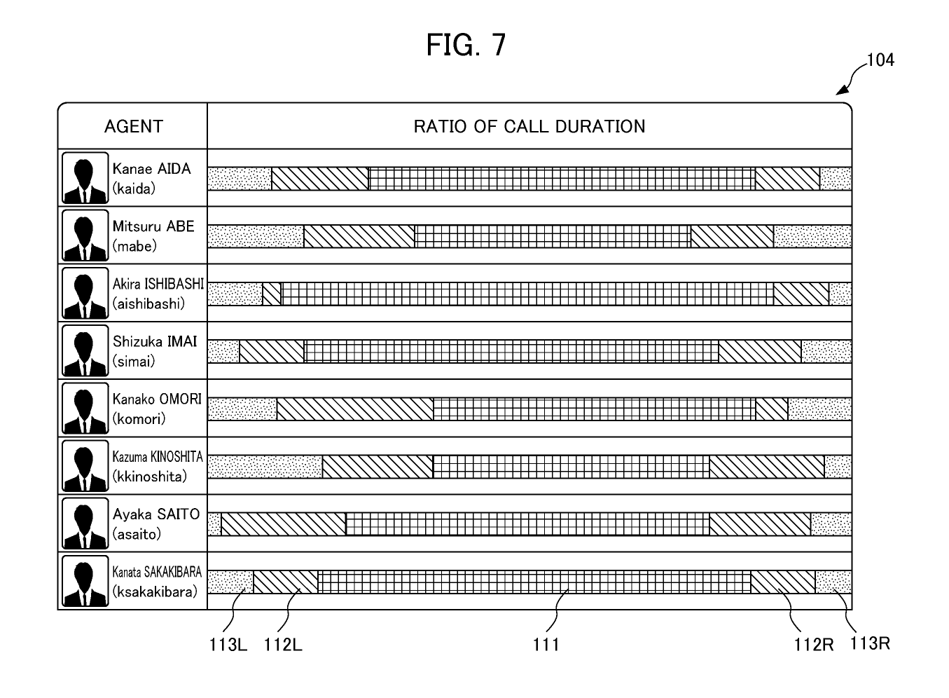

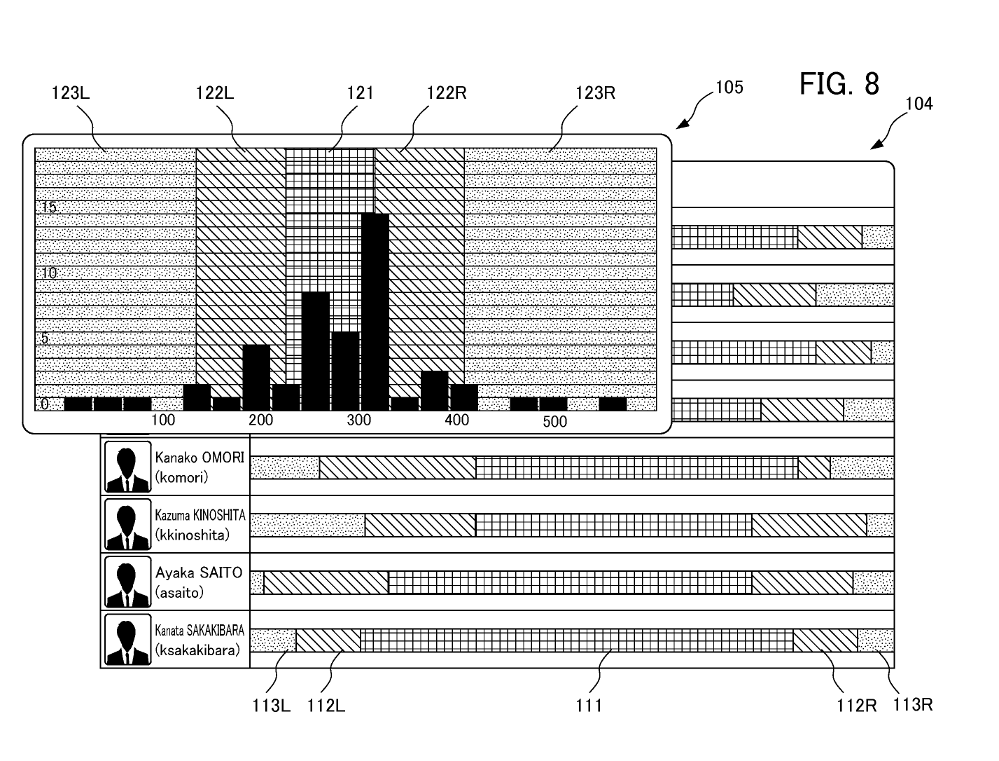

On the other hand, an example to which the graph method, i.e. a method of expressing “the degree of evenness of durations for each call in a predetermined state” with a graph indicating a distribution state of durations of each call in a predetermined state, is applied is illustrated in FIGS. 7 and 8 described later.

In a case of such a graph index method being applied, for example, the evaluation index generation part 14 generates, as evaluation index information, information used for calculating the evaluation indices such as a duration (call duration), the number of times (frequency) and “center value”, for each call in each state such as “call-talk” for each agent.

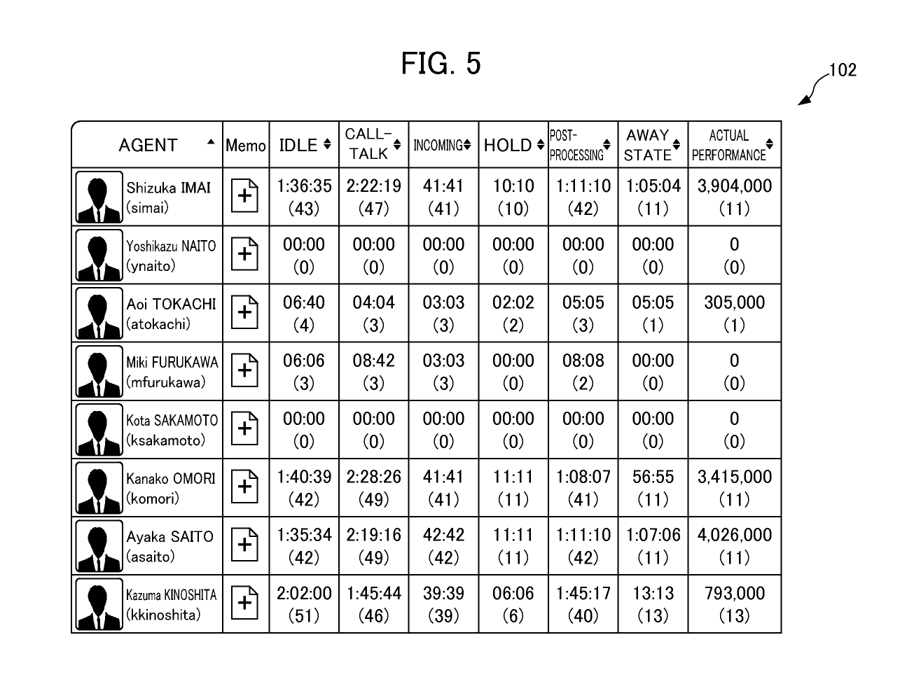

In the following, with reference to FIGS. 5 to 8, specific examples of display images to which the present invention is applied are explained.

The image generation part 15 generates data of a second screen 102 as shown in FIG. 5 as an example.

Second screen 102 refers to a screen in which accumulated values of durations for each call in each state for each agent and the number of times (accumulated number of times of each state) are listed.

In the list of the second screen 102, each row corresponds to each agent and each column except for “Memo” corresponds to each state. For each state, “idle”, “call-talk”, “incoming”, “hold”, “post-processing”, “away state”, and “actual performance” are provided. That is to say, in an item at a predetermined row and a predetermined column, an accumulated value (of history) of duration of each call for a state corresponding to the predetermined column for an agent corresponding to the predetermined row is shown above, and the number of times (history) for a state corresponding to the predetermined column for an agent corresponding to the predetermined row is shown below with parentheses. More specifically, for example, the item at the first row from the top and the fourth column from the left indicates that an accumulated value of durations of each call (call duration or call-talk time) for the “call-talk” state corresponding to the first row and the fourth column of “Shizuka Imai” is “2:22:19” and the number of times thereof is “47”.

It should be noted that the item of “Memo” in the second column from the left is an item that allows various information relating to each agent to be stored in text-data format. The item of “Memo” is similarly treated in the screen 103 of FIG. 6 described later.

Here, the second screen 102 has not yet been a display image indicating an evaluation index to which the present invention is applied, i.e. a display image that expresses “the degree of evenness of a duration for each call in a predetermined state”

Therefore, in the following, as three examples of display images indicating evaluation indices to which the present invention is applied, the third screen 103 shown in FIG. 6, a fourth screen 104 shown in FIG. 7, and a fifth screen 105 shown in FIG. 8 are described individually in this order.

It should be noted that, although the “call-talk” state is adopted as a predetermined state for the third screen 103 shown in FIG. 6, the fourth screen 104 shown in FIG. 7, and the fifth screen 105 shown in FIG. 8, respectively, this is merely an example, and another state (for example, the state shown in each column of the second screen 102 of FIG. 5) may be adopted.

For example, the image generation part 15 can generate data of the third screen 103 shown as the example of FIG. 6, as data of a display image expressing with “the degree of evenness of durations for each call in a predetermined state”.

The third screen 103 refers to a screen in which statistic information of durations of each call in a predetermined state (in the present example, a “call-talk” state) for each agent is listed.

In the list of the third screen 103, each row corresponds to each agent and each column except for “Memo” corresponds to each piece of statistic information. Regarding each piece of statistic information, “the number of times”, “AHT”, “center value”, “dispersion”, and “standard deviation” for the “call-talk” state are provided. That is to say, in an item at a predetermined row and a predetermined column, a value of statistic information regarding a call duration or call-talk time (a duration in a predetermined state) corresponding to the predetermined column for an agent corresponding to the predetermined row is shown. More specifically, for example, the item at the first row from the top and the sixth column from the left, indicates that “dispersion” corresponding to the first row and the sixth column of “Aida Kanae” is “2500”.

Here, the values of “dispersion”, and “standard deviation” among each column are examples indicating “the degree of evenness of durations for each call in a predetermined state”. Therefore, a manager can evaluate easily and promptly each agent by comparing at least one of “dispersion” and “standard deviation” for each agent.

In other words, since there is a tendency for smaller values of “dispersion” and “standard deviation” output a higher “degree of evenness of a duration for each call in a predetermined state”, it is possible for the manager to evaluate that an agent with such scores is likely to be a high-quality agent.

Furthermore, for example, the image generation part 15 generates data of the fourth screen 104 shown as the example of FIG. 7, as data of a display image expressing “the degree of evenness of durations for each call in a predetermined state”.

The fourth screen 104 refers to a screen in which a band graph showing a distribution state of durations of each call (in the present example, “call-talk” state) in a predetermined state for each agent is displayed.

The band graph in the fourth screen 104 is configured with three kinds of bands are arranged.

More specifically, durations of each call in a predetermined state (in the present example, “call-talk” state) for each predetermined operator are classified in multiple-stages, depending on how far the durations are away from the center value. In the present embodiment, the durations are classified into three stages based on thresholds set in advance.

Here, a stage classified as a duration close to the center value is referred to as “first stage”, a stage classified as a duration relatively away from the center value is referred to as “second stage”, and a stage classified as a duration substantially away from the center value is referred to as “third stage”.

In the example of FIG. 7, the band 111 indicates the first stage, the bands 112L and 112R indicate the second stage, and the bands 113L and 113R indicate the third stage.

Here, in the example of FIG. 7, each of the bands is set to a length according to its frequency (the number of times classified into each stage). Then, each band indicating each stage is distinguished by different types of hatching. It should be noted that it is preferable for the respective bands indicating each state to be easily recognized visually when being distinguished based on different colors on an actual screen.

In addition, in the example of FIG. 7, the band 111 indicating the first stage is arranged at the center. For this reason, the band indicating the second stage is divided into the band 112L indicating a shorter duration than that of the center value and the band 112R indicating a longer duration than that of the center value, and the band 112L is arranged at the left side of the band 111 and the band 112R is arranged at the right side of the band 111. Similarly, the band indicating the third stage is divided into the band 113L indicating a shorter duration than that of the center value and the band 113R indicating a longer duration than that of the center value, and the band 113L is arranged at the left side of the band 112L (i.e. the left side of the band 111) and the band 113R is arranged at the right side of the band 112R (i.e. the right side of the band 111).

In this way, in the fourth screen 104, the distribution state of durations (here, call duration of each call) of each call in a predetermined state for each agent is shown by way of the band graphs for each agent. Here, the distribution state of durations of each call in a predetermined state is an example showing “the degree of evenness of durations for each call in a predetermined state”.

Therefore, a manager can easily and promptly evaluate each agent by comparing band graphs for each agent. Furthermore, when comparing with the numerical values (screen 103 of FIG. 6), due to visual effect from the graph, the manager can make intuitive evaluation since it is possible for the manager to visually recognize the distribution state of durations of each call in a predetermined state intuitively.

As a specific evaluation, since there is a tendency for “the degree of evenness of durations for each call in a predetermined state” to rise with the band 111 of the first stage being longer, it is possible for the manager to evaluate that an agent with such a score is likely to be a high-quality agent.

Moreover, for example, if the bands 111 of the first stage have similar lengths for two agents, the manager can evaluate the agents by comparison based on whether the band of the first stage is displaced from the center to the left side or the right side, and if it is displaced, how greatly it is displaced.

In other words, the matter of the band of the first stage being displaced from the center to the left side or right side indicates that the length of the bands 112L and 112R of the second stage or the length of the bands 113L and 113R of the third stage are not even, i.e. it tends to be too much shorter or too much longer than the center value in the second stage or the third stage. This indicates that there is a tendency for “the degree of evenness of durations for each call in a predetermined state” to lower as the band of the first stage is displaced from the center to the left side or right side.

Therefore, if the bands 111 of the first stage have similar lengths, the manager can evaluate that an agent whose band of the first stage is closer to the center is likely to be a higher quality agent.

Furthermore, for example, the image generation part 15 generates data of the fifth screen 105 shown as the example of FIG. 8, as data of a display image expressing “the degree of evenness of durations for each call in a predetermined state”.

The fifth screen 105 refers to a screen in which a histogram showing a distribution state of durations (here, call duration) of each call in a predetermined state, for a predetermined agent designated by a click operation using the input unit 40 (FIG. 1), from among a plurality of agents displayed on the fourth screen 104 is displayed.

In the fifth screen 105, a region 121 indicates “first stage” classified as a duration close to the center value and corresponds to the band 111 of the fourth screen 104. Regions 122L and 122R indicate “second stage” classified as durations relatively away from the center value and correspond to the bands 112L and 112R of the fourth screen 104. Regions 123L and 123R indicate “third stage” classified as durations substantially away from the center value and correspond to the bands 113L and 113R of the fourth screen 104.

Here, in the example of FIG. 8, each region indicating each stage of the fifth screen 105 is distinguished by way of different types of hatching, and they correspond to each band of the fourth screen 104. In other words, the same hatching is used in the same stages for both the fourth screen 104 and the fifth screen 105. With such an arrangement, an operator (manager) can easily visually recognize each stage between the fourth screen 104 and the fifth screen 105. It should be noted that it is preferable for the respective regions indicating each stage of the fifth screen 105 to be easily recognized visually when being distinguished based on different colors on an actual screen (however, colors should correspond to each band of the fourth screen 104).

The vertical axis represents frequency (the number of times classified into each stage), and the classes of the histogram in the example of FIG. 8 are further classified into 16 classes which are classified more finely than the abovementioned three stages.

In this way, in the fifth screen 105, a distribution state of durations (here, call duration) of each call in a predetermined state for a predetermined agent selected from among a plurality of agents shown on the fourth screen 104 is shown by way of histogram. As described above, the distribution state of durations of each call in a predetermined state is an example indicating “the degree of evenness of durations for each call in a predetermined state”.

Here, as described above, the classes in the histogram of the fifth screen 105 are classified into 16 classes, which are finer as compared with the divided number (three stages) of the bands in the fourth screen 104.

Therefore, it is possible for the manager to evaluate the predetermined agent finer by checking the histogram of the predetermined agent.

As a specific evaluation, even if the bands 111 of the first stage in the screen 104 of FIG. 7 have similar lengths, there is a tendency for “the degree of evenness of durations for each call in a predetermined state” to rise with the frequency around the center of the histogram of the screen 105 of FIG. 8 (the center of the region 121) being high. Therefore, in the screen 104 of FIG. 7, for example, if the bands 111 of the first stage have similar lengths for two agents, the manager can evaluate by further comparing with the screen 105 of FIG. 8, that an agent whose histogram is more focused on the center is likely to be a higher quality agent.

Here, the regions 121, 122L, 122R, 123L, and 123R of the fifth screen 105 correspond to the bands 111, 112L, 112R, 113L, and 113R, respectively, and the display form (the types of hatching in the example of FIG. 8, color difference, etc., on an actual screen) also corresponds thereto. With such visual effects using a consistent display form, the manager can make a more intuitive evaluation since it is possible for the manager to compare the fourth screen 104 with the fifth screen 105 intuitively.

Although the embodiments of the present invention are described above, the present invention is not limited to the abovementioned embodiments. Furthermore, the effects described in the present embodiments are merely exemplified as the most preferable effects derived from the present invention. Therefore, the effects derived from the present invention are not limited to those described in the present embodiments.

For example, although the items included in the columns of the second screen 102 of FIG. 5 such as the “call-talk” state are adopted for the state of an agent in the abovementioned embodiment, the present invention is not limited thereto, and any state can be adopted.

Furthermore, for example, although the history data is generated from fragment data in the abovementioned embodiment, the present invention is not limited thereto, and can be generated from any information from which the history of duration in a predetermined state can be understood. However, with the present embodiments in which history data is generated from fragment data, it is possible to more easily understand the history of responses to one call, and more appropriate evaluation becomes possible since the duration of each call in each state such as call duration can be recognized more accurately.

In other words, the history management apparatus 1 to which the present invention is applied can be satisfied so long as including the following such history generation part, evaluation index generation part, image generation part, and display control part.

A history generation part generates a history data set including a duration of each call in each state for each of a plurality of agents.

With a degree of evenness of durations for each call in a predetermined state for a predetermined agent as an evaluation index, an evaluation index generation part generates information indicating the evaluation index itself or information used for calculating the evaluation index, as information of an evaluation index based on the history data.

An image generation part generates a data set of a display image indicating the evaluation index based on the information of the evaluation index.

A display control part causes the display image to be displayed on a display unit.

The history management apparatus 1 having such a configuration can display on a display unit a display image indicating an evaluation index, with a degree of evenness of durations for each call in a predetermined state as the evaluation index for a predetermined agent. Therefore, it is possible for a user (manager) viewing the display image to evaluate each agent appropriately.

Here, the history management apparatus 1 can further include an acquisition part that acquires a fragment data set indicating an action of a switchboard in relation to a call and an execution time of the action. The history generation part can generate the history data set indicating a history of states of an agent to one call, from a plurality of fragment data sets acquired by the acquisition part.

Since the history management apparatus 1 can generate history data based on such fragment data, it is possible to easily understand the history of responses to one call, and it is also possible to make a more appropriate evaluation since the duration of each call in each state such as call duration can be recognized more accurately.

Furthermore, in the history management apparatus 1, the evaluation index generation unit can generate, as the information of the evaluation index, at least one of a dispersion and standard deviation of durations of the predetermined state for the predetermined agent, and the image generation part can generate data of the display image indicating the information of the evaluation index.

With such a configuration, a user (manager) can easily and promptly evaluate each agent by comparing values of “dispersion” or “standard deviation” for each agent.

Furthermore, in the history management apparatus 1, the evaluation index generation part can generate, as the information of the evaluation index, information for calculating a distribution state of durations in the predetermined state for the predetermined agent, and the image generation part can generate data of the display image including a band graph or a histogram indicating a distribution state of durations in the predetermined state based on the information of the evaluation index.

With such a configuration, a user (manager) can easily and promptly evaluate each agent by comparing the band graph or the histogram for each agent. Furthermore, when compared with the numerical values, due to visual effect from the graph, the manager can make a more intuitive evaluation since it is possible for the manager to visually recognize the distribution state of durations of each call in a predetermined state intuitively.

The history management apparatus 1 may be a variety of information processing apparatuses (computer) such as a server apparatus, a PC (Personal Computer), and a tablet terminal, in which the abovementioned functions are realized by software. In a case of being realized by software, programs constituting the software are installed to an information processing apparatus. Furthermore, these programs may be recorded in removable media such as a CD-ROM to be distributed, or may be downloaded via a network to an information processing apparatus to be distributed.

In addition, the functions of the history management apparatus 1 may be partially distributed to the CTI 3, another server, or the like. In this case, the processing load at the manager's terminal having a display function is reduced.

What is claimed is:

1. A history management apparatus, comprising:
a history generation part that generates a history data set including a duration of each call in each state for each of a plurality of agents;
an evaluation index generation part that, with a degree of evenness of durations for each call in a predetermined state for a predetermined agent as an evaluation index, generates information indicating the evaluation index itself or information used for calculating the evaluation index, as information of an evaluation index based on the history data;
an image generation part that generates a data set of a display image indicating the evaluation index based on the information of the evaluation index; and
a display control part that causes the display image to be displayed on a display unit.

2. The history management apparatus according to claim 1, further comprising:
an acquisition part that acquires a fragment data set indicating an action of a switchboard in relation to a call and an execution time of the action,
wherein the history generation part generates the history data set indicating a history of states of an agent to one call, from a plurality of fragment data sets acquired by the acquisition part.

3. The history management apparatus according to claim 1,
wherein the evaluation index generation unit generates, as the information of the evaluation index, at least one of a dispersion and standard deviation of durations of the predetermined state for the predetermined agent, and
wherein the image generation part generates data of the display image indicating the information of the evaluation index.

4. The history management apparatus according to claim 1,
wherein the evaluation index generation part generates, as the information of the evaluation index, information for calculating a distribution state of durations in the predetermined state for the predetermined agent, and
wherein the image generation part generates data of the display image including a band graph or a histogram indicating a distribution state of durations in the predetermined state based on the information of the evaluation index.

5. A history management method executed by a computer, comprising:
a history generation step of generating a history data set including a duration of each call in each state for each of a plurality of agents;
an evaluation index generation step of, with a degree of evenness of durations for each call in a predetermined state for a predetermined agent as an evaluation index, generating information indicating the evaluation index itself or information used for calculating the evaluation index, as information of an evaluation index based on the history data;
an image generation step of generating a data set of a display image indicating the evaluation index based on the information of the evaluation index; and
a display control step of causing the display image to be displayed on a display unit.

6. A non-transitory computer-readable medium encoded with a history management program that enables a computer to execute:
a history generation step of generating a history data set including a duration of each call in each state for each of a plurality of agents;
an evaluation index generation step of, with a degree of evenness of durations for each call in a predetermined state for a predetermined agent as an evaluation index, generating information indicating the evaluation index itself or information used for calculating the evaluation index, as information of an evaluation index based on the history data;
an image generation step of generating a data set of a display image indicating the evaluation index based on the information of the evaluation index; and
a display control step of causing the display image to be displayed on a display unit.
